(19) United States
(12) Patent Application Publication
(10) Pub. No.: US 2025/0367963 A1
(43) Pub. Date: Dec. 4, 2025

(54) DECORATIVE MEMBER, RESIN MOLDED PRODUCT, AND DECORATIVE DISPLAY DEVICE

(71) Applicant: Dai Nippon Printing Co., Ltd., Tokyo (JP)

(72) Inventors: Kazuyuki Sakonaka, Tokyo (JP); Naoki Oota, Tokyo (JP); Akihisa Noda, Tokyo (JP)

(73) Assignee: Dai Nippon Printing Co., Ltd., Tokyo (JP)

(21) Appl. No.: 18/852,048

(22) PCT Filed: Mar. 31, 2023
(86) PCT No.: PCT/JP2023/013672

§ 371 Date: Sep. 27, 2024

(30) Foreign Application Priority Data
Mar. 31, 2022 (JP) 2022-060856

(51) Int. Cl. B44F 1/06; B44F 1/04; B44F 1/08

(52) U.S. Cl. CPC B44F 1/066; B44F 1/04; B44F 1/08

(57) ABSTRACT

A decorative member has a first surface displaying a design and a second surface opposite the first surface. The decorative member includes a decorative layer and a light absorber in this order from the first surface toward the second surface. The decorative layer forms the design. The light absorber is disposed in a predetermined pattern. The light absorber overlays the decorative layer. The decorative layer transmits at least a portion of light incident on each position. The decorative layer includes a first layer including a colorant expressing a cyan-based color, a second layer including a colorant expressing a magenta-based color, and a third layer including a colorant expressing a yellow-based color. The first layer, the second layer, and the third layer overlay one another in a section of the decorative layer.

### TECHNICAL FIELD

The present disclosure relates to decorative members, resin molded products having decorative members, and decorative display devices having decorative members or resin molded products.

### BACKGROUND ART

Display devices displaying display objects, such as icons, are widely used. A display device forms a display object by using a light absorber disposed in a predetermined pattern to block a portion of light from a light source. When the display object is in a non-displayed state, the display device is normally observed in black color. For example, for a surface member of, for example, an automobile, furniture, or housing construction material, design is extremely important. It is desired that a display device applied to various fields not only displays a display object but also has a design that harmonizes with the surrounding environment.

In order to add design to the display device, it is conceivable to combine the display device with a decorative member. For example, a decorative member described in PCT International Publication No. WO 2021/002061 can add a design that can harmonize with the surrounding environment of the display device by forming the design in accordance with a decorative layer. In order for light to be transmitted through the decorative member and a display object to be displayed properly, the decorative member is partially semi-transparent.

### Disclosure of Invention

In order to display the design, the decorative member may sometimes have different transmittances for respective wavelengths at each position in the semi-transparent section. The light transmitted through the decorative member may sometimes be colored locally or entirely. If the decorative layer includes a large amount of colorant, such as carbon black, expressing a black-based color, the light transmitted through the decorative member tends to be colored. When the light transmitted through the decorative member is colored, the display object formed by the light transmitted through the decorative member is not properly displayed. An object of the present disclosure is to cause the decorative member to properly transmit the light.

The present disclosure relates to [1] to indicated below.
[1] A decorative member having a first surface displaying a design and a second surface opposite the first surface, the decorative member comprising:
a decorative layer forming a design and a light absorber disposed in a predetermined pattern and overlaying the decorative layer, the decorative layer and the light absorber being provided sequentially from the first surface toward the second surface,
wherein the decorative layer transmits at least a portion of light incident on each position,
wherein the decorative layer includes a first layer including a colorant expressing a cyan-based color, a second layer including a colorant expressing a magenta-based color, and a third layer including a colorant expressing a yellow-based color, and
wherein the first layer, the second layer, and the third layer overlay one another in a section of the decorative layer.
[2] The decorative member according to [1], wherein a concentration of a colorant expressing a black-based color and included in each of the first layer, the second layer, and the third layer is 5% or lower.
[3] The decorative member according to [1] or [2],
wherein a concentration of the colorant expressing the cyan-based color in the first layer is 60% or higher,
wherein a concentration of the colorant expressing the magenta-based color in the second layer is higher than 50%,
wherein a concentration of the colorant expressing the yellow-based color in the third layer is higher than 50%, and
wherein a section where the first layer is disposed at the first surface of the decorative member expresses a dark color.
[4] The decorative member according to any one of [1] to [3], further comprising:
a reflective layer disposed between the decorative layer and the light absorber,
wherein the reflective layer reflects light from the first surface.
[5] A decorative member having a first surface displaying a design and a second surface opposite the first surface, the decorative member comprising:
a decorative layer forming a design and an adjustment layer overlaying the decorative layer, the decorative layer and the adjustment layer being provided sequentially from the first surface toward the second surface,
wherein the decorative layer transmits at least a portion of light incident on each position,
wherein the adjustment layer has a uniform single chromatic color, and
wherein a ratio of an average transmittance of light in a wavelength range between 500 nm or higher and 700 nm or lower to an average transmittance of light in a wavelength range between 420 nm or higher and 500 nm or lower in the decorative member is 1.0 or higher and 1.3 or lower.
[6] A decorative member having a first surface displaying a design and a second surface opposite the first surface, the decorative member comprising:
a decorative layer forming a design and an adjustment layer overlaying the decorative layer, the decorative layer and the adjustment layer being provided sequentially from the first surface toward the second surface,
wherein the decorative layer transmits at least a portion of light incident on each position,
wherein the adjustment layer has a uniform single chromatic color, and
wherein an average transmittance of light in a wavelength range between 420 nm or higher and 500 nm or lower is lower than an average transmittance of light in a wavelength range between 500 nm or higher and 700 nm or lower in the decorative layer, and
wherein an average transmittance of light in the wavelength range between 420 nm or higher and 500 nm or lower is higher than an average transmittance of light in the wavelength range between 500 nm or higher and 700 nm or lower in the adjustment layer.
[7] The decorative member according to [6], wherein a ratio of an average transmittance of light in the wavelength range between 500 nm or higher and 700 nm or lower to an average transmittance of light in the wavelength range between 420 nm or higher and 500 nm or lower in the decorative member is 1.0 or higher and 1.3 or lower.
[8] The decorative member according to any one of [5] to [7], further comprising:
a light absorber disposed in a predetermined pattern and overlaying the decorative layer,
wherein the adjustment layer is disposed between the light absorber and the decorative layer.
[9] The decorative member according to any one of [5] to [8], further comprising:
a reflective layer disposed between the decorative layer and the adjustment layer,
wherein the reflective layer reflects light from the first surface.
[10] The decorative member according to any one of [5] to [9], wherein a thickness of the adjustment layer is 0.5 μm or more and 3.0 μm or less.
[11] The decorative member according to any one of [5] to [10],
wherein the decorative layer includes a first layer including a colorant expressing a cyan-based color, a second layer including a colorant expressing a magenta-based color, and a third layer including a colorant expressing a yellow-based color, and
wherein the first layer, the second layer, and the third layer overlay one another in a section of the decorative layer.
[12] A decorative member having a first surface displaying a design and a second surface opposite the first surface, the decorative member comprising:
a decorative layer forming a design,
wherein the decorative layer transmits at least a portion of light incident on each position,
wherein the decorative layer includes a first layer including a colorant expressing a cyan-based color, a colorant expressing a magenta-based color, and a colorant expressing a yellow-based color, and
wherein a section of the decorative layer forms a dark-colored design.
[13] A decorative member having a first surface displaying a design and a second surface opposite the first surface, the decorative member comprising:
a decorative layer forming a design,
wherein the decorative layer transmits at least a portion of light incident on each position,
wherein the decorative layer includes a first layer and a second layer including a colorant expressing a cyan-based color and at least one of a colorant expressing a magenta-based color and a colorant expressing a yellow-based color,
wherein, in the second layer, a concentration of at least one of the colorant expressing the magenta-based color and the colorant expressing the yellow-based color is higher than a concentration of the colorant expressing the cyan-based color,
wherein a section where the first layer is disposed at the first surface of the decorative member expresses a dark color, and
wherein the first layer and the second layer overlay each other in a section of the decorative layer.
[14] The decorative member according to any one of [1] to [13], wherein the decorative layer further includes a self-colored layer that is uniformly single chromatic throughout the decorative layer.
[15] The decorative member according to any one of [1] to [4], [11], and [13],
wherein the decorative layer forms a woodgrain design including a vessel pattern, and
wherein the first layer is disposed in correspondence with the vessel pattern.
[16] A resin molded product comprising:
the decorative member according to any one of [1] to [15]; and
a molded resin layer overlaying the second surface of the decorative member.
[17] A decorative display device comprising:
the decorative member according to any one of [1] to or the resin molded product according to [16]; and
a light source disposed closer to the second surface than to the first surface.

According to the present disclosure, light can be properly transmitted through the decorative member.

### BRIEF DESCRIPTION OF DRAWINGS

FIG. 1 is a cross-sectional view illustrating an example of a decorative display device according to the present disclosure.

FIG. 2 is an enlarged cross-sectional view illustrating a decorative layer of a decorative member in FIG. 1.

FIG. 3 is a further enlarged cross-sectional view illustrating the decorative layer in FIG. 2.

FIG. 4 is an enlarged cross-sectional view illustrating a reflective layer.

FIG. 5 is a front view illustrating a state where the decorative display device is not displaying a display object.

FIG. 6 is a front view illustrating a state where the decorative display device is displaying a display object.

FIG. 7 illustrates an example of a method for manufacturing the decorative member.

FIG. 8 illustrates the example of the method for manufacturing the decorative member.

FIG. 9 illustrates another example of the method for manufacturing the decorative member.

FIG. 10 is a cross-sectional view corresponding to FIG. 3 and illustrating a modification of the decorative layer.

FIG. 11 is a cross-sectional view corresponding to FIG. 3 and illustrating another modification of the decorative layer.

### DESCRIPTION OF EMBODIMENTS

An embodiment of the present invention will now be described with reference to the drawings. The scales and the vertical-to-horizontal dimensional ratios in the drawings attached to this description have been changed and exaggerated from those in actuality for illustrative purposes and for the ease of understanding.

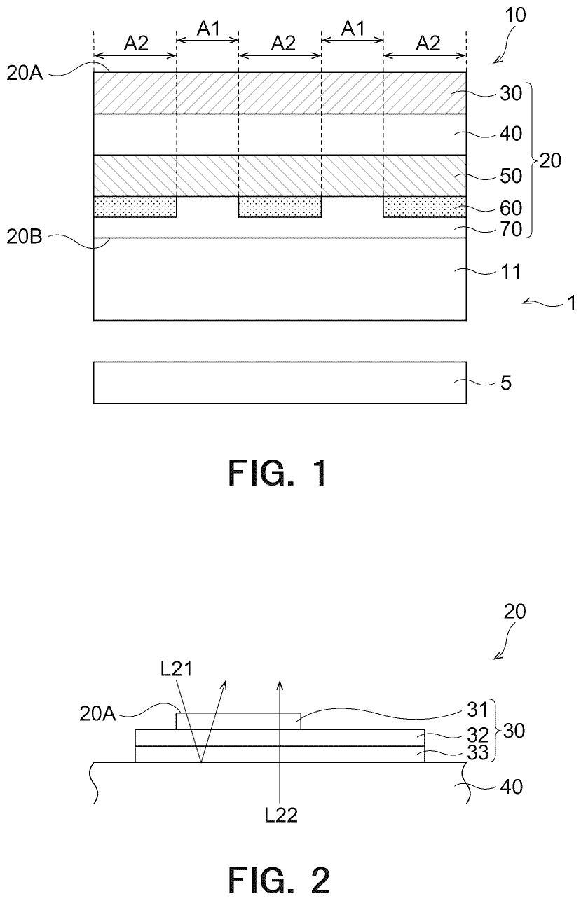

FIG. 1 is a cross-sectional view schematically illustrating a decorative display device 1 according to this embodiment. As shown in FIG. 1, the decorative display device 1 has a light source 5 and a resin molded product 10. The resin molded product 10 has a molded resin layer 11 and a decorative member 20. The decorative member 20 is tabular. The decorative member 20 has a first surface 20A and a second surface 20B. The second surface 20B is a surface opposite the first surface 20A. The first surface 20A and the second surface 20B are tabular surfaces of the decorative member 20. The decorative member 20 displays a design on the first surface 20A. The molded resin layer 11 overlays the second surface 20B of the decorative member 20. The decorative member 20 includes a first zone A1 where light is readily transmittable and a second zone A2 where light is less likely to be transmitted. The second zone A2 has a predetermined pattern corresponding to a display object displayed by the decorative display device 1. When the light source 5 is not radiating light, the decorative display device 1 entirely displays the design added by the decorative member 20. The design displayed by the decorative display device 1 includes a plurality of chromatic colors. For example, the decorative display device 1 displays a woodgrain design including a vessel pattern. The decorative display device 1 may display another design. When the light source 5 is radiating light, the decorative display device 1 can display the display object in accordance with the pattern of the second zone A2. In the second zone A2 where light is less likely to be transmitted, the decorative display device 1 displays the design added by the decorative member 20 even when the light source 5 is radiating light.

Although the resin molded product 10 is tabular in the shown example, the resin molded product 10 may have a desired shape by conforming to the shape of a mold when the molded resin layer 11 is formed. For example, the resin molded product 10 may be curved or bent to include a recessed shape, a protruding shape, or both of these shapes.

As shown in FIG. 1, the decorative member 20 has a decorative layer 30, a reflective layer 40, an adjustment layer 50, a light absorber 60, and a transparent resin layer 70 in this order from the first surface 20A toward the second surface 20B. The adjustment layer 50 and the light absorber 60 overlay the decorative layer 30. The reflective layer 40 and the adjustment layer 50 are disposed between the decorative layer 30 and the light absorber 60. The reflective layer 40 is disposed between the decorative layer 30 and the adjustment layer 50. The light absorber 60 is disposed in the second zone A2.

The decorative member 20 may have another layer that is not shown. For example, the decorative member 20 may have a layer for surface protection. The decorative member 20 may have an adhesive layer for bonding layers to each other.

The light source 5 radiates light onto the decorative member 20. In the example shown in FIG. 1, the light source 5 is disposed closer to the second surface 20B than to the first surface 20A of the decorative member 20. In other words, the light source 5 is disposed closer to the light absorber 60 or the adjustment layer 50 than to the decorative layer 30 of the decorative member 20. The light source 5 radiates light onto the second surface 20B of the decorative member 20. The light source 5 radiates light onto the decorative member 20 from near the light absorber 60 or the adjustment layer 50 relative to the decorative layer 30. A portion of the light radiated onto the decorative member 20 is absorbed by the light absorber 60, whereas the remaining portion is transmitted through the first zone A1 of the decorative member 20 so that a display object is displayed. In order to make the intensity of the light transmitted through the decorative member 20 uniform, for example, the light source 5 used is preferably a surface light source device that emits light planarly. The light source 5 is, for example, an LED.

The molded resin layer 11 supports the decorative member 20. The molded resin layer 11 is transparent. The molded resin layer 11 is less likely to inhibit the light from the light source 5 and the design displayed by the decorative member 20. The molded resin layer 11 is provided by in-mold molding or insert molding. By molding, the molded resin layer 11 can be provided with a desired shape. Examples of the material of the molded resin layer 11 include glass and resin, such as acrylic resin, polycarbonate, ABS, PET, and polypropylene.

The term “transparent” used in this description implies that a visible light transmittance, determined as an average transmittance value at each wavelength, when measured at every 0.5 nm within a measured wavelength range between 380 nm or higher and 780 nm or lower by using a spectrophotometer (standard integrating-sphere type UH4150 manufactured by Hitachi, Ltd.) is 50% or higher, preferably, 80% or higher. The spectrophotometer used is a two-hole ¢60-mm standard full integrating sphere. With regard to an incidence angle at the time of measurement of the visible light transmittance, if the direction of transmission is not particularly specified, the incidence angle is set to 0°. The incidence angle is an angle formed by the traveling direction of incident light relative to the direction normal to an incidence plane, and is a value below 90°. If the area of a target measurement location is small and is smaller than a measurement area of the device, the transmittance is evaluated by being compared with an object, such as a film, with a known transmittance measured in advance in accordance with the above-described method. For example, films with transmittance of 60% and 90% are prepared, and the brightness of the film, the clarity of an LED light source, and so on are visually inspected when LED light is radiated from the opposite surface to be visually inspected. On the other hand, the target measurement location is visually inspected by using a same LED light source to radiate light onto the target measurement location from the opposite surface to be visually inspected, and compared. If the state of transmission at the measurement location appears that the transmittance is higher than 60% of the known film but not higher than 90% of the known film, the transmittance at the measurement location is evaluated to be between 60% and 90%. The size of the LED light source is desirably more similar to the area of the measurement location for visual confirmation. For example, if the width of the measurement location is 5 mm, the LED light source has a size where the diameter, when circular, or the length of the larger side, when rectangular, ranges between 2 mm and 10 mm, and more desirably, between 2 mm and 5 mm. The distance between the LED light source and the target object is desirably 50 mm or less. Furthermore, with the distance being between 5 mm and 10 mm and the LED light source having the aforementioned size, when the LED light is transmitted and is visually inspected, the shape of the LED light source can also be checked, thereby facilitating the comparison of the transmittances.

The decorative member 20 displays the design on the first surface 20A to add the design to the decorative display device 1. In order to display a good design, the design displayed by the decorative member 20 preferably includes a plurality of chromatic colors. The decorative member 20 transmits a portion of the light from the light source 5.

The decorative layer 30 forms the design to be displayed by the decorative member 20. More specifically, light incident on the decorative layer 30 from the outside is reflected, so that the design formed by the decorative layer 30 is observed from the outside. The design that can be formed by the decorative layer 30 may be a pictorial pattern, such as a graphic, pattern, color, picture, photograph, character, mark, pictogram, text, or number. As a design that can harmonize with the surrounding environment where the decorative display device 1 is provided, the decorative layer 30 can form, for example, a woodgrain-like or marble-like pictorial pattern or a geometrical pattern. In particular, the decorative layer 30 can form a woodgrain design including a vessel pattern. In order to form a good design, the decorative layer 30 preferably forms a design including a plurality of chromatic colors.

The decorative layer 30 can transmit at least a portion of light incident on each position. The decorative layer 30 can transmit the light from the light source 5 at each position. The decorative layer 30 may have a part that transmits the entire incident light. The decorative layer 30 may partially be transparent. In order to form a design, the decorative layer 30 may have a different transmittance for every wavelength at each position. For example, if the decorative layer 30 forms a woodgrain design including a vessel pattern, the section with the vessel pattern has a lower transmittance than the other sections. For example, if the decorative layer 30 forms a woodgrain design including a vessel pattern, an average transmittance of light in a wavelength range between 420 nm or higher and 500 nm or lower in the decorative layer 30 is lower than an average transmittance of light in a wavelength range between 500 nm or higher and 700 nm or lower. The ratio of the average transmittance of light in the wavelength range between 500 nm or higher and 700 nm or lower to the average transmittance of light in the wavelength range between 420 nm or higher and 500 nm or lower in the decorative layer 30 is 1.4 or higher and 2.4 or lower.

In this description, the transmittance of a target member is measured by measuring the transmittance at each wavelength using a spectrophotometer (standard integrating-sphere type UH4150 manufactured by Hitachi, Ltd.). A two-hole ϕ60-mm standard full integrating sphere is used. For the measurement, a D65 light source is used as a light source. The average transmittance is determined as an average obtained by measuring the transmittance for every 0.5-nm wavelength.

FIG. 2 is an enlarged view of the decorative layer 30 in the decorative member 20. In order to form a design of a desired color, the decorative layer 30 includes a plurality of layers expressing different kinds of colors. In detail, as shown in FIG. 2, the decorative layer 30 includes a first layer 31 including a colorant expressing a cyan-based color, a second layer 32 including a colorant expressing a magenta-based color, and a third layer 33 including a colorant expressing a yellow-based color. The decorative layer 30 may include only the first layer 31, the second layer 32, and the third layer 33.

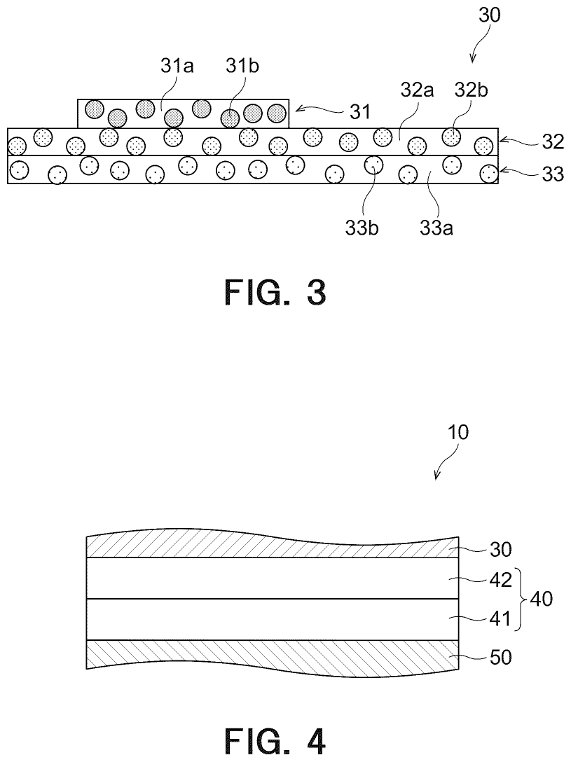

FIG. 3 is a further enlarged view of the decorative layer 30. As shown in FIG. 3, the first layer 31 includes a first binder resin 31a and a first colorant 31b contained in the first binder resin 31a and expressing the cyan-based color. The second layer 32 includes a second binder resin 32a and a second colorant 32b contained in the second binder resin 32a and expressing the magenta-based color. The third layer 33 includes a third binder resin 33a and a third colorant 33b contained in the third binder resin 33a and expressing the yellow-based color.

Each of the first binder resin 31a, the second binder resin 32a, and the third binder resin 33a is a resin, such as urethane resin, acrylic polyol resin, acrylic resin, ester resin, amide resin, butyral resin, styrene resin, urethane-acrylic copolymer, vinyl chloride-vinyl acetate copolymer resin, vinyl chloride-vinyl acetate-acrylic copolymer resin, chlorinated propylene resin, nitrocellulose resin, or cellulose acetate resin.

The first colorant 31b is a cyan-based-color pigment or organic filler, and is, for example, a phthalocyanine blue. A maximum absorption wavelength range in the visible region of the first colorant 31b is 600 nm or higher. The second colorant 32b is a magenta-based-color pigment or organic filler, and is, for example, a quinacridone. A maximum absorption wavelength range in the visible region of the second colorant 32b is 480 nm or higher and lower than 600 nm. The third colorant 33b is a yellow-based-color pigment or organic filler, and is, for example, an isoindoline. A maximum absorption wavelength range in the visible region of the third colorant 33b is lower than 480 nm.

Each of the first layer 31, the second layer 32, and the third layer 33 may include a colorant expressing another kind of color, but hardly includes a colorant expressing a black-based color. The concentration of the colorant expressing the black-based color included in each of the first layer 31, the second layer 32, and the third layer 33 may be 5% or lower, 3% or lower, 1% or lower, or 0.5% or lower. Each of the first layer 31, the second layer 32, and the third layer 33 does not have to include the colorant expressing the black-based color. The concentration of the first colorant 31b expressing the cyan-based color in the first layer 31 may be 60% or higher. The concentration of the second colorant 32b expressing the magenta-based color in the second layer 32 may be higher than 50%. The concentration of the third colorant 33b expressing the yellow-based color in the third layer 33 may be higher than 50%. In the second layer 32, the concentration of a colorant expressing a cyan-based color is lower than the concentration of a colorant expressing a yellow-based color. In the third layer 33, the concentration of a colorant expressing a cyan-based color is lower than the concentration of a colorant expressing a magenta-based color.

The colorant concentration in each layer indicates the ratio of the weight of each colorant to the weight of all the colorants in the layer. With regard to the colorant concentration, the cross section of each layer is obtained, the cross section of a target layer is observed by using a magnifying microscope, and the areas of the colorants within an observation area are compared. The ratio of the areas of the colorants is regarded as the volume ratio, and the weight ratio of each colorant is calculated based on the molecular weight of the material of the colorant. The weight ratios of the colorants in cross sections at three locations are calculated, the values of the calculated weight ratios in the respective cross sections are averaged out, and the averaged value is set as the weight ratio of each colorant.

The transmittance of each of the first layer 31, the second layer 32, and the third layer 33 is, for example, 30% or higher and 70% or lower. The thickness of each of the first layer 31, the second layer 32, and the third layer 33 is, for example, 1.0 μm or more and 3.0 μm or less.

The first layer 31, the second layer 32, and the third layer 33 appropriately overlay one another, so that the decorative layer 30 can express a desired color. The first layer 31, the second layer 32, and the third layer 33 are appropriately disposed at respective positions of the decorative layer 30 in accordance with the design to be formed by the decorative layer 30. For example, in a certain section of the decorative layer 30, only any one of the first layer 31, the second layer 32, and the third layer 33 is disposed. In another section of the decorative layer 30, any two of the first layer 31, the second layer 32, and the third layer 33 are disposed to overlay each other. In yet another section of the decorative layer 30, the first layer 31, the second layer 32, and the third layer 33 overlay one another. In particular, with the first layer 31, the second layer 32, and the third layer 33 overlaying one another, the decorative layer 30 can express a dark color while hardly including a layer expressing black color, such as carbon black. For example, if the decorative layer 30 forms a woodgrain design including a dark vessel pattern, the first layer 31, the second layer 32, and the third layer 33 are disposed to overlay one another at a position corresponding to the vessel pattern.

In this description, a dark color refers to a color with low brightness and low saturation. In detail, in a color chart (COLOR FINDER by Toyo Ink Co., Ltd.), a dark color includes all colors included in Grayish tone, all colors included in Dark tone, all colors included in Dark Grayish tone, CF10547,CF10548, and CF10744 included in Light Grayish tone, CF10823, CF10838, CF10842, CF10843, CF10845, CF10848, CF10868, CF10885, CF10899, CF10901, CF10935, CF10941, CF10942, CF10949, CF10950, and CF10978 included in Dull tone, and CF10804, CF10808, CF10832, CF10837, CF10839, CF10910, CF10916, CF10918, CF10931, CF10932, CF10933, CF10948, CF10954, CF10960, CF10971, CF10976, and CF10981 included in Deep tone. In this description, the color is determined as the most similar color in the color chart (COLOR FINDER by Toyo Ink Co., Ltd.).

If the concentration of the colorant expressing the cyan-based color in the first layer 31 is 60%, the first layer 31 can express the dark color. At the first surface 20A of the decorative member 20, the section where the first layer 31 is disposed expresses the dark color.

Each of the first layer 31, the second layer 32, and the third layer 33 is not provided in the entire decorative layer 30. Each of the first layer 31, the second layer 32, and the third layer 33 is provided only in a section of the decorative layer 30.

The reflective layer 40 reflects light from the first surface 20A, which transmitted through the decorative layer 30. The reflective layer 40 is disposed between the decorative layer 30 and the adjustment layer 50 such that the light transmitted through the decorative layer 30 is not reflected after being transmitted through the adjustment layer 50. The reflective layer 40 is disposed between the decorative layer 30 and the light absorber 60 such that the reflected light is not inhibited by the light absorber 60. The reflectance of the reflective layer 40 is, for example, 30% or higher and 80% or lower. The transmittance of the reflective layer 40 is, for example, 20% or higher and 70% or lower. The thickness of the reflective layer 40 is, for example, 1.0 μm or more and 3.0 μm or less. The reflective layer 40 is white-colored or silver-colored to readily avoid color mixing with the decorative layer 30. In order to reflect light with an appropriate reflectance, the reflective layer 40 includes, for example, flaky aluminum.

FIG. 4 is an enlarged cross-sectional view of the reflective layer 40. As shown in FIG. 4, the reflective layer 40 may include a reflector 41 and a reflectance adjuster 42 that adjusts the reflectance of the reflective layer 40. The reflector 41 includes, for example, flaky aluminum. The reflectance adjuster 42 includes a white pigment, such as titanium oxide. The reflectance adjuster 42 is disposed closer toward the decorative layer 30, that is, closer toward the first surface 20A, than the reflector 41.

In this description, the reflectance of a target member is measured by measuring the reflectance at each wavelength using a spectrophotometer (“CM-3700A” manufactured by Konica Minolta). For the measurement, a D65 light source is used as a light source.

In order to form a design, the decorative layer 30 may have a different transmittance for each wavelength. The adjustment layer 50 adjusts the transmittance of the decorative member 20 to reduce a difference in transmittance for each wavelength of the decorative member 20. The adjustment layer 50 has a kind of color serving as a complementary color of the decorative layer 30. In detail, the ratio of the average transmittance of light in the wavelength range between 500 nm or higher and 700 nm or lower to the average transmittance of light in the wavelength range between 420 nm or higher and 500 nm or lower is substantially an inverse ratio between the decorative layer 30 and the adjustment layer 50. For example, if the decorative layer 30 forms a woodgrain design including a vessel pattern, the average transmittance of light in the wavelength range between 420 nm or higher and 500 nm or lower in the adjustment layer 50 is higher than the average transmittance of light in the wavelength range between 500 nm or higher and 700 nm or lower in conformity with the decorative layer 30. With such an adjustment layer 50, the ratio of the average transmittance of light in the wavelength range between 500 nm or higher and 700 nm or lower to the average transmittance of light in the wavelength range between 420 nm or higher and 500 nm or lower in the decorative member 20 is 1.0 or higher and 1.3 or lower.

The adjustment layer 50 has a uniform single chromatic color. To serve as a complementary color for the decorative layer 30, the adjustment layer 50 includes a pigment or organic filler corresponding to the color of the design formed by the decorative layer 30. The pigment or organic filler that the adjustment layer 50 may include is, for example, a phthalocyanine blue.

The adjustment layer 50 is disposed between the decorative layer 30 and the light absorber 60 such that the adjustment layer 50 can adjust the transmittance of the decorative member 20 without being inhibited by the light absorber 60. The reflective layer 40 is disposed between the decorative layer 30 and the adjustment layer 50 such that the adjustment layer 50 does not inhibit the design formed by the decorative layer 30. The thickness of the adjustment layer 50 is 0.5 μm or more and 3.0 μm or less.

The light absorber 60 absorbs light from the light source 5. The transmittance of the light absorber 60 is, for example, 0.1% or lower. The light absorber 60 is disposed in a predetermined pattern to overlay the second zone A2. The pattern in which the light absorber 60 is disposed corresponds to the shape of the display object displayed by the decorative display device 1. Light is readily transmitted through the first zone A1 where the light absorber 60 is not disposed, whereas light is less likely to be transmitted through the second zone A2 where the light absorber 60 is disposed, so that the display object, such as an icon, displayed by the decorative display device 1 is formed. The light absorber 60 is disposed closer toward the light source 5 than the decorative layer 30. In the example shown in FIG. 1, the light absorber 60 is provided so as to be embedded in the transparent resin layer 70. The thickness of the light absorber 60 is 1.0 μm or more and 10 μm or less. The light absorber 60 includes, for example, carbon black as a light absorbing material.

The molded resin layer 11 may be provided by various molding methods. If the molded resin layer 11 is provided by in-mold molding, the transparent resin layer 70 bonds the decorative member 20 to the molded resin layer 11. The transparent resin layer 70 is a so-called adhesive layer. For the purpose of enhancing adhesiveness and contact between a decorative sheet and a molded resin, an adhesive layer is provided, where necessary, at the outermost surface, located toward the molded resin layer, of the decorative sheet. The resin for forming the adhesive layer is not particularly limited so long as it can enhance the adhesiveness and contact between the decorative sheet and the molded resin. An example of the resin for forming the adhesive layer is a thermoplastic resin. Examples of the thermoplastic resin include acrylic resin, acrylic modified polyolefin resin, chlorinated polyolefin resin, vinyl chloride-vinyl acetate copolymer, thermoplastic urethane resin, thermoplastic polyester resin, polyamide resin, and rubber-based resin. The thermoplastic resin used may be of a single kind alone or may be a combination of two or more kinds.

Alternatively, if the molded resin layer 11 is provided by insert molding, the transparent resin layer 70 supports the components that the decorative member 20 has. With the transparent resin layer 70, an appropriate thickness for handling the decorative member 20 can be achieved. The transparent resin layer 70 is a transparent film-like member. The transparent resin layer 70 is composed of, for example, an acrylic material. The transparent resin layer 70 has a thickness of, for example, 10 μm or more and 500 μm or less.

The operation of the decorative display device 1 according to this embodiment will now be described. FIG. 2 illustrates light L21 entering the decorative member 20 from the outside and light L22 from the light source 5.

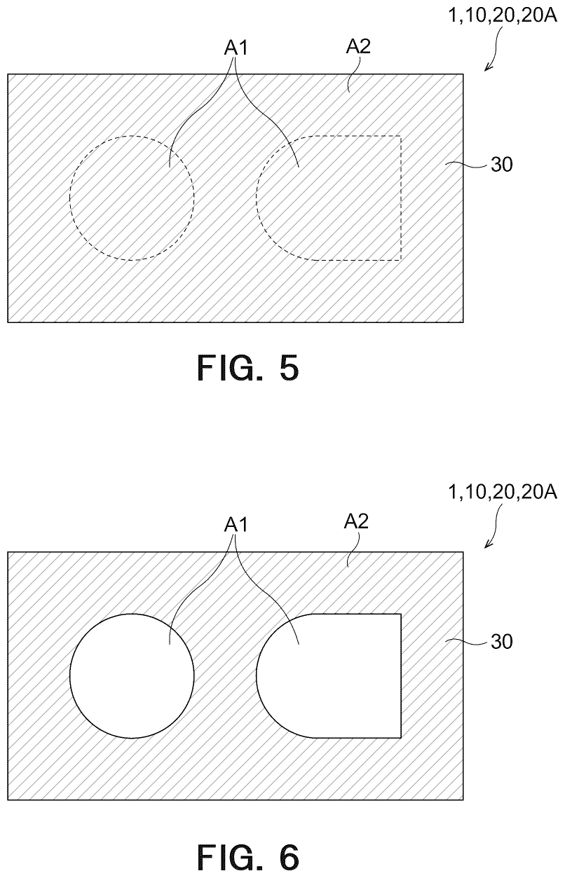

The light L21 incident on the first surface 20A of the decorative member 20 from the outside is transmitted through layers included in the decorative layer 30 at each position. The light L21 shown in FIG. 2 is transmitted through the three layers, namely, the first layer 31, the second layer 32, and the third layer 33, of the decorative layer 30. The light L21 transmitted through the decorative layer 30 is reflected by the reflective layer 40. The light incident on the first surface 20A of the decorative member 20 is less likely to enter the adjustment layer 50 and the light absorber 60. The adjustment layer 50 and the light absorber 60 are less likely to be observed depending on the light incident on the first surface 20A of the decorative member 20. The light L21 reflected by the reflective layer 40 is transmitted again through each layer included in the decorative layer 30. Subsequently, the light L21 is output outside the decorative member 20 and is observed by an outside observer. Because the light L21 transmitted through each layer included in the decorative layer 30 is transmitted twice through the decorative layer 30, the light L21 is clearly observed as a color corresponding to the layers of the decorative layer 30 through which the light L21 has been transmitted. In particular, the light L21 transmitted through the three layers, namely, the first layer 31, the second layer 32, and the third layer 33, is observed as a dark color. For example, the vessel pattern in the woodgrain design is observed as a dark color. Accordingly, when the light source 5 is not radiating light, the decorative display device 1 entirely displays a design intended for observation, as shown in FIG. 5. With the displayed design, the decorative display device 1 can harmonize with the surrounding environment.

The light L22 radiated from the light source 5 is transmitted through the decorative member 20 in the first zone A1. In accordance with the design formed by the decorative layer 30, the light L22 is transmitted through at least one of the first layer 31, the second layer 32, and the third layer 33 in the first zone A1. The light L22 shown in FIG. 2 is transmitted through the three layers, namely, the first layer 31, the second layer 32, and the third layer 33, of the decorative layer 30. The transmitted light L22 is output outside the decorative member 20 and is observed by an outside observer. Because the light L22 is transmitted only once through the decorative layer 30, the light L22 is less likely to be observed as the color corresponding to the layers of the decorative layer 30 even if the light L22 is transmitted through the decorative layer 30. In the second zone A2, the light L22 is absorbed by the light absorber 60. When light is radiated from the light source 5, the light radiated from the light source 5 is readily transmitted through the first zone A1 of the decorative member 20 but is less likely to be transmitted through the second zone A2, whereby the decorative display device 1 displays a display object, as shown in FIG. 6. As shown in FIG. 6, in the second zone A2, the decorative display device 1 displays a design intended for observation.

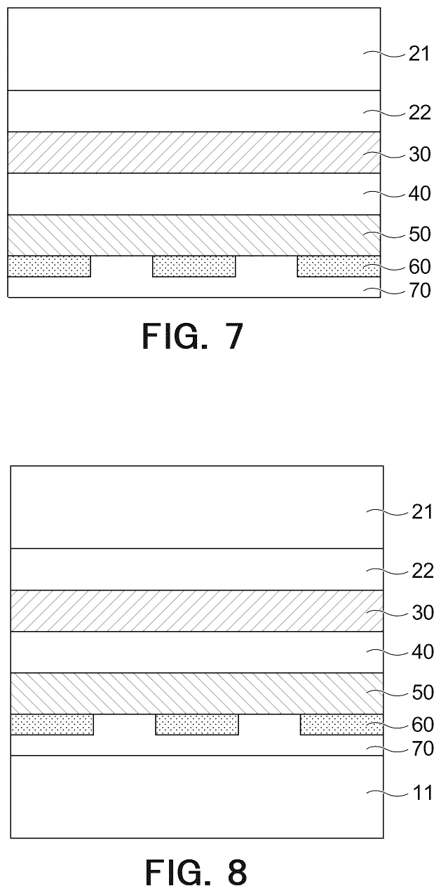

An example of a method for manufacturing the resin molded product 10 having the decorative member 20 will now be described. As shown in FIG. 7, a release layer 22 composed of, for example, polyethylene terephthalate given a release treatment is provided on a substrate 21 composed of, for example, acrylic resin. The release layer 22 is provided with the decorative layer 30 by, for example, printing. The decorative layer 30 is provided by sequentially printing a first layer including a colorant expressing a cyan-based color, a second layer including a colorant expressing a magenta-based color, and a third layer including a colorant expressing a yellow-based color. The decorative layer 30 is provided to form a desired design. The reflective layer 40 including flaky aluminum is provided on the decorative layer 30 by, for example, printing. The adjustment layer 50 is provided on the reflective layer 40 by, for example, printing. The light absorber 60 having a predetermined pattern corresponding to a display object is formed on the adjustment layer 50 by, for example, printing. The transparent resin layer 70 is provided to cover the light absorber 60. The transparent resin layer 70 has adhesiveness.

By in-mold molding, the molded resin layer 11 bonded to the transparent resin layer 70 is provided, as shown in FIG. 8. The release layer 22 is released from the decorative layer 30. The substrate 21 and the release layer 22 are removed. As a result of the above process, the resin molded product 10 having the decorative member 20 shown in FIG. 1 is manufactured.

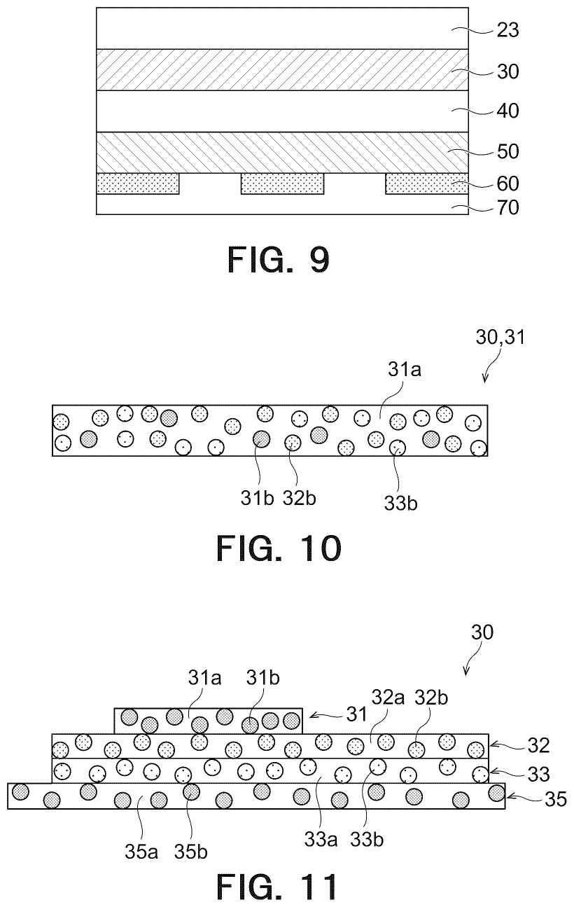

Another example of the method for manufacturing the resin molded product 10 having the decorative member 20 will now be described. As shown in FIG. 9, the decorative layer 30 is provided on a substrate 23 composed of, for example, an acrylic resin or an ionizing radiation-curable resin by, for example, printing. The decorative layer 30 is provided by sequentially printing a first layer including a colorant expressing a cyan-based color, a second layer including a colorant expressing a magenta-based color, and a third layer including a colorant expressing a yellow-based color. The decorative layer 30 is provided to form a desired design. The reflective layer 40 including flaky aluminum is provided on the decorative layer 30 by, for example, printing. The adjustment layer 50 is provided on the reflective layer 40 by, for example, printing. The light absorber 60 having a predetermined pattern corresponding to a display object is formed on the adjustment layer 50 by, for example, printing. The transparent resin layer 70 is provided to cover the light absorber 60.

By insert molding, the molded resin layer 11 is provided on the transparent resin layer 70. As a result of the above process, the resin molded product 10 having the decorative member 20 shown in FIG. 1 is manufactured. The substrate 23 serves as a surface protection layer, not shown in FIG. 1, for the decorative member 20.

In order to display a dark-colored section, such as a dark section, in a displayed design, the decorative member in the related art uses a large amount of black pigment, such as carbon black. When the design to be displayed by the decorative member has a dark section, the transmittance in the section is lower than that in other sections. For example, if the decorative member displays a woodgrain design, the transmittance in a section with a woodgrain vessel pattern is lower than that in other sections. Such a section may sometimes unintentionally interfere with light from a light source. If the transmittance significantly varies from section to section of the decorative member depending on the color of the design, the light cannot be properly transmitted through the decorative member, thus resulting in the display object being observed to be colored even when the display object is displayed in accordance with the light from the light source.

The decorative member can display a chromatically-colored design by having different transmittances for respective wavelengths. In the decorative member in the related art, the transmittance varies from wavelength to wavelength, so that when the light from the light source is transmitted through the decorative member, the light cannot be properly transmitted through the decorative member, sometimes causing the light to be colored in the color which is displayed by the decorative member. The display object is observed in a color different from the intended color.

Depending on the design displayed by the decorative member, the light transmitted through the decorative member may sometimes be colored locally or entirely. The light cannot be properly transmitted through the decorative member, and the display object is sometimes not displayed properly depending on the design displayed by the decorative member.

In order to properly display the display object by properly transmitting the light through the decorative member, it is conceivable to reduce the thickness of the decorative layer that forms the design of the decorative member. When the thickness of the decorative layer that forms the design of the decorative member is reduced, the decorative member cannot properly display the design.

In the decorative member 20 according to this embodiment, the decorative layer 30 includes the first layer 31 expressing the cyan-based color, the second layer 32 expressing the magenta-based color, and the third layer 33 expressing the yellow-based color. With the first layer 31, the second layer 32, and the third layer 33 overlaying one another, a dark-colored section, such as a dark section, can be formed in the design formed by the decorative layer 30 while each of the first layer 31, the second layer 32, and the third layer 33 hardly includes a colorant, such as carbon black, expressing a black-based color. Because each of the first layer 31, the second layer 32, and the third layer 33 has a higher transmittance than a black-colored layer using, for example, carbon black, light can be properly transmitted through the decorative member 20. The decorative display device 1 having the decorative member 20 can properly display the display object.

The concentration of the colorant expressing the cyan-based color in the first layer 31 is 60% or higher. The first layer 31 can clearly express a cyan-based dark color. The concentration of the colorant expressing the magenta-based color in the second layer 32 is higher than 50%. The second layer 32 can clearly express the magenta-based color. The concentration of the colorant expressing the yellow-based color in the third layer 33 is higher than 50%. The third layer 33 can clearly express the yellow-based color. On the first surface 20A of the decorative member 20, the section where the first layer 31 is disposed expresses a dark color. While enhancing the color of the design displayed by the decorative layer 30, the dark section can be formed in the design formed by the decorative layer 30 while each of the first layer 31, the second layer 32, and the third layer 33 hardly includes a colorant, such as carbon black, expressing a black-based color.

The decorative member 20 according to this embodiment has the adjustment layer 50. The ratio of the average transmittance of light in the wavelength range between 500 nm or higher and 700 nm or lower to the average transmittance of light in the wavelength range between 420 nm or higher and 500 nm or lower is substantially an inverse ratio between the decorative layer 30 and the adjustment layer 50. In accordance with the adjustment layer 50, the ratio of the average transmittance of light in the wavelength range between 500 nm or higher and 700 nm or lower to the average transmittance of light in the wavelength range between 420 nm or higher and 500 nm or lower in the decorative member 20 can be set to 1.0 or higher and 1.3 or lower. In the entire decorative member 20, there is hardly any difference in transmittance for each wavelength. Even when the light from the light source 5 is transmitted through the decorative member 20, the light is less likely to be colored to the color of the design displayed by the decorative member. The light can be properly transmitted through the decorative member 20. The decorative display device 1 having the decorative member 20 can properly display the display object.

The average transmittance of light in the wavelength range between 420 nm or higher and 500 nm or lower is lower than the average transmittance of light in the wavelength range between 500 nm or higher and 700 nm or lower in the decorative layer 30, and the average transmittance of light in the wavelength range between 420 nm or higher and 500 nm or lower is higher than the average transmittance of light in the wavelength range between 500 nm or higher and 700 nm or lower in the adjustment layer 50. In the entire decorative member 20, the difference in transmittance for each wavelength is small. Even when the light from the light source 5 is transmitted through the decorative member 20, the light is less likely to be colored to the color of the design displayed by the decorative member. The light can be properly transmitted through the decorative member 20. The decorative display device 1 having the decorative member 20 can properly display the display object.

The adjustment layer 50 has a uniform single chromatic color. With a simple configuration, the adjustment layer 50 can cause the decorative member 20 to properly transmit light.

The decorative member 20 has the reflective layer 40. The reflective layer 40 is disposed between the decorative layer 30 and the light absorber 60 and between the decorative layer 30 and the adjustment layer 50. With this arrangement, the light transmitted through the decorative layer 30 is not reflected after being transmitted through the adjustment layer 50, and the light reflected at the reflective layer 40 is not inhibited by the light absorber 60. Observation of the adjustment layer 50 and the light absorber 60 due to the light entering from the first surface 20A of the decorative member 20 is suppressed. Because the light transmitted through the decorative layer 30 is reflected by the reflective layer 40, the light is transmitted twice through the decorative layer 30. The design formed by the decorative layer 30 is clearly observed in the color corresponding to the layers of the decorative layer 30 through which the light has been transmitted. Because the transmittance of the reflective layer 40 is sufficiently high, the reflective layer 40 is less likely to inhibit the light from the light source 5.

The thickness of the adjustment layer 50 is 0.5 μm or more and 3.0 μm or less. With the adjustment layer 50 having an appropriate thickness, a difference in transmittance for each wavelength can be properly reduced in the entire decorative member 20. The light from the light source 5 is less likely to be colored by the decorative member 20. The light can be properly transmitted through the decorative member 20.

The decorative member 20 according to this embodiment has the first surface 20A displaying a design and the second surface 20B opposite the first surface 20A. The decorative member 20 includes, in the following order from the first surface 20A toward the second surface 20B, the decorative layer 30 displaying the design and the light absorber 60 disposed in the predetermined pattern and overlaying the decorative layer 30. The decorative layer 30 transmits at least a portion of light incident on each position. The decorative layer 30 includes the first layer 31 expressing the cyan-based color, the second layer 32 expressing the magenta-based color, and the third layer 33 expressing the yellow-based color. The first layer 31, the second layer 32, and the third layer 33 overlay one another in a section of the decorative layer 30. The first layer 31, the second layer 32, and the third layer 33 each have a higher transmittance than a black-colored layer, such as carbon black, so that light can be properly transmitted through the decorative member 20.

The decorative member 20 according to this embodiment has the first surface 20A displaying a design and the second surface 20B opposite the first surface 20A. The decorative member 20 includes, in the following order from the first surface 20A toward the second surface 20B, the decorative layer 30 displaying the design and the adjustment layer 50 overlaying the decorative layer 30. The decorative layer 30 transmits at least a portion of light incident on each position. The adjustment layer 50 has a uniform single chromatic color. The ratio of the average transmittance of light in the wavelength range between 500 nm or higher and 700 nm or lower to the average transmittance of light in the wavelength range between 420 nm or higher and 500 nm or lower in the decorative member 20 is 1.0 or higher and 1.3 or lower. In the entire decorative member 20, there is hardly any difference in transmittance for each wavelength. Even when the light from the light source 5 is transmitted through the decorative member 20, the light is less likely to be colored in the color which is displayed by the decorative member. The light can be properly transmitted through the decorative member 20.

The decorative member 20 according to this embodiment has the first surface 20A displaying a design and the second surface 20B opposite the first surface 20A. The decorative member 20 includes, in the following order from the first surface 20A toward the second surface 20B, the decorative layer 30 displaying the design and the adjustment layer 50 overlaying the decorative layer 30. The decorative layer 30 transmits at least a portion of light incident on each position. The adjustment layer 50 has a uniform chromatic color. The average transmittance of light in the wavelength range between 420 nm or higher and 500 nm or lower is lower than the average transmittance of light in the wavelength range between 500 nm or higher and 700 nm or lower in the decorative layer 30. The average transmittance of light in the wavelength range between 420 nm or higher and 500 nm or lower is higher than the average transmittance of light in the wavelength range between 500 nm or higher and 700 nm or lower in the adjustment layer 50. In the entire decorative member 20, the difference in transmittance for each wavelength is small. Even when the light from the light source 5 is transmitted through the decorative member 20, the light is less likely to be colored in the color which is displayed by the decorative member. The light can be properly transmitted through the decorative member 20.

The aspects of the present disclosure are not limited to the embodiment described above and include various modifications conceivable by a skilled person, and the advantages of the present disclosure are not limited to the contents described above. Specifically, various additions, modifications, and partial deletions are possible so long as they do not depart from the conceptual spirit and scope of the present disclosure derived from the contents described in the claims and equivalents thereof.

In the above embodiment, the decorative layer 30 includes the first layer 31 expressing the cyan-based color, the second layer 32 expressing the magenta-based color, and the third layer 33 expressing the yellow-based color. In the decorative layer 30, one of the second layer 32 and the third layer 33 may be omitted. If the second layer 32 is omitted, at least one of the first layer 31 and the third layer 33 may further include the second colorant 32b expressing the magenta-based color. If the third layer 33 is omitted, at least one of the first layer 31 and the second layer 32 may further include the third colorant 33b expressing the yellow-based color. In such a decorative layer 30, a section where the first layer 31 and the second layer 32 overlay each other forms a dark-colored design. While each of the first layer 31 and the second layer 32 hardly includes a colorant, such as carbon black, expressing a black-based color, a dark section can be formed in the design formed by the decorative layer 30.

FIG. 10 is an enlarged cross-sectional view illustrating a modification of the decorative layer 30. In the example shown in FIG. 10, the decorative layer 30 does not include the second layer 32 and the third layer 33. The decorative layer 30 includes the first layer 31 alone. In this modification, the first layer 31 includes the first binder resin 31a, the first colorant 31b expressing the cyan-based color, the second colorant 32b expressing the magenta-based color, and the third colorant 33b expressing the yellow-based color. The first colorant 31b, the second colorant 32b, and the third colorant 33b are contained in the first binder resin 31a. In other words, the first colorant 31b, the second colorant 32b, and the third colorant 33b are mixed in a single layer. In observation from the first surface 20A, the first colorant 31b, the second colorant 32b, and the third colorant 33b overlay one another in a section of the decorative layer 30. This section of the decorative layer 30 forms a dark-colored design. While hardly including a colorant, such as carbon black, expressing a black-based color, the decorative layer 30 can form a dark section in the design formed by the decorative layer 30. Light can be properly transmitted through the decorative member 20. The decorative display device 1 having the decorative member 20 can properly display a display object.

FIG. 11 is an enlarged cross-sectional view illustrating another modification of the decorative layer 30. In the example shown in FIG. 11, the decorative layer 30 further includes a chromatic self-colored layer 35 provided uniformly over the entire decorative layer 30. The self-colored layer 35 forms a background color for the design formed by the decorative layer 30. With the self-colored layer 35, the decorative layer 30 can form a better design. The self-colored layer 35 is disposed closer toward the second surface 20B than to the first surface 20A of the decorative member 20 relative to the first layer 31, the second layer 32, and the third layer 33.

The self-colored layer 35 includes a fourth binder resin 35a and a fourth colorant 35b contained in the fourth binder resin 35a. The self-colored layer 35 may express any color. The fourth colorant 35b may be, for example, a pigment of any color. The fourth colorant 35b may express a black-based color of, for example, carbon black. The fourth colorant 35b is uniformly distributed throughout the entire fourth binder resin 35a.

The self-colored layer 35 is provided on the release layer 22 shown in FIG. 7 prior to the first layer 31, the second layer 32, and the third layer 33 by, for example, printing.

Because the self-colored layer 35 is uniformly chromatic throughout the entire decorative layer 30, the transmittance in a section of the decorative member 20 is less likely to be lower than that in other sections due to the self-colored layer 35. Specifically, unevenness in transmittance caused by the self-colored layer is less likely to occur. Light can be properly transmitted through the decorative member 20. The decorative display device 1 having the decorative member 20 can properly display a display object.

The above embodiment and the modifications can be appropriately combined with each other.

1. A decorative member having a first surface displaying a design and a second surface opposite the first surface, the decorative member comprising:
a decorative layer forming a design and a light absorber disposed in a predetermined pattern and overlaying the decorative layer, the decorative layer and the light absorber being provided sequentially from the first surface toward the second surface,
wherein the decorative layer transmits at least a portion of light incident on each position,
wherein the decorative layer includes a first layer including a colorant expressing a cyan-based color, a second layer including a colorant expressing a magenta-based color, and a third layer including a colorant expressing a yellow-based color, and
wherein the first layer, the second layer, and the third layer overlay one another in a section of the decorative layer.

2. The decorative member according to claim 1, wherein a concentration of a colorant expressing a black-based color and included in each of the first layer, the second layer, and the third layer is 5% or lower.

3. The decorative member according to claim 1,
wherein a concentration of the colorant expressing the cyan-based color in the first layer is 60% or higher,
wherein a concentration of the colorant expressing the magenta-based color in the second layer is higher than 50%,
wherein a concentration of the colorant expressing the yellow-based color in the third layer is higher than 50%, and
wherein a section where the first layer is disposed at the first surface of the decorative member expresses a dark color.

4. The decorative member according to claim 1, further comprising:
a reflective layer disposed between the decorative layer and the light absorber,
wherein the reflective layer reflects light from the first surface.

5. A decorative member having a first surface displaying a design and a second surface opposite the first surface, the decorative member comprising:
a decorative layer forming a design and an adjustment layer overlaying the decorative layer, the decorative layer and the adjustment layer being provided sequentially from the first surface toward the second surface,
wherein the decorative layer transmits at least a portion of light incident on each position,
wherein the adjustment layer has a uniform single chromatic color, and
wherein a ratio of an average transmittance of light in a wavelength range between 500 nm or higher and 700 nm or lower to an average transmittance of light in a wavelength range between 420 nm or higher and 500 nm or lower in the decorative member is 1.0 or higher and 1.3 or lower.

6. A decorative member having a first surface displaying a design and a second surface opposite the first surface, the decorative member comprising:
a decorative layer forming a design and an adjustment layer overlaying the decorative layer, the decorative layer and the adjustment layer being provided sequentially from the first surface toward the second surface,
wherein the decorative layer transmits at least a portion of light incident on each position,
wherein the adjustment layer has a uniform single chromatic color, and
wherein an average transmittance of light in a wavelength range between 420 nm or higher and 500 nm or lower is lower than an average transmittance of light in a wavelength range between 500 nm or higher and 700 nm or lower in the decorative layer, and
wherein an average transmittance of light in the wavelength range between 420 nm or higher and 500 nm or lower is higher than an average transmittance of light in the wavelength range between 500 nm or higher and 700 nm or lower in the adjustment layer.

7. The decorative member according to claim 6, wherein a ratio of an average transmittance of light in the wavelength range between 500 nm or higher and 700 nm or lower to an average transmittance of light in the wavelength range between 420 nm or higher and 500 nm or lower in the decorative member is 1.0 or higher and 1.3 or lower.

8. The decorative member according to claim 5, further comprising:
a light absorber disposed in a predetermined pattern and overlaying the decorative layer,
wherein the adjustment layer is disposed between the light absorber and the decorative layer.

9. The decorative member according to claim 5, further comprising:
a reflective layer disposed between the decorative layer and the adjustment layer,
wherein the reflective layer reflects light from the first surface.

10. The decorative member according to claim 5, wherein a thickness of the adjustment layer is 0.5 μm or more and 3.0 ∞m or less.

11. The decorative member according to claim 5,
wherein the decorative layer includes a first layer including a colorant expressing a cyan-based color, a second layer including a colorant expressing a magenta-based color, and a third layer including a colorant expressing a yellow-based color, and
wherein the first layer, the second layer, and the third layer overlay one another in a section of the decorative layer.

12. (canceled)

13. (canceled)

14. The decorative member according to claim 1, wherein the decorative layer further includes a self-colored layer that is uniformly single chromatic throughout the decorative layer.

15. The decorative member according to claim 1,
wherein the decorative layer forms a woodgrain design including a vessel pattern, and
wherein the first layer is disposed in correspondence with the vessel pattern.

16. A resin molded product comprising:
the decorative member according to claim 1; and
a molded resin layer overlaying the second surface of the decorative member.

17. A decorative display device comprising:
the decorative member according to claim 1; and
a light source disposed closer to the second surface than to the first surface.

18. The decorative member according to claim 6, further comprising:
a light absorber disposed in a predetermined pattern and overlaying the decorative layer,
wherein the adjustment layer is disposed between the light absorber and the decorative layer.

19. The decorative member according to claim 6, further comprising:
a reflective layer disposed between the decorative layer and the adjustment layer,
wherein the reflective layer reflects light from the first surface.

20. The decorative member according to claim 6, wherein a thickness of the adjustment layer is 0.5 μm or more and 3.0 μm or less.

21. The decorative member according to claim 6,
wherein the decorative layer includes a first layer including a colorant expressing a cyan-based color, a second layer including a colorant expressing a magenta-based color, and a third layer including a colorant expressing a yellow-based color, and
wherein the first layer, the second layer, and the third layer overlay one another in a section of the decorative layer.

22. A resin molded product comprising:
the decorative member according to claim 5; and
a molded resin layer overlaying the second surface of the decorative member.
